(19) United States
(12) Patent Application Publication
(10) Pub. No.: US 2003/0032509 A1
(43) Pub. Date: Feb. 13, 2003

(54) Chain tension apparatus for providing derailleur adjustments on a bicycle

(76) Inventor: Bruce Alan Thompson, Granite Bay, CA (US)

Correspondence Address: Dr. Bruce A. Thompson, 6700 Auburn Folsom Road, Granite Bay, CA, 95746-7334, US

(21) Appl. No.: 09/928,302

(22) Filed: Aug. 13, 2001

(51) Int. Cl. F16H 7/14; F16H 7/12

(52) U.S. Cl. 474/135; 474/117; 474/133; 474/138

(57) ABSTRACT

Use of the present invention enables the alignment and servicing of the rear derailleur of a bicycle without having the rear wheel or a specialized fixture mounted in the dropouts. For the present invention, the apparatus is placed on the frame of the bicycle and the chain routed over a toothed pulley. A tensioning spring in the apparatus provides the proper chain tension and allows the rear derailleur to be serviced or aligned.

### BRIEF DESCRIPTION

The subject of this invention relates to the bicycle industry. Specifically, this invention concerns an apparatus for adjusting the rear chain derailleur without the need for the presence of a rear wheel. Additionally, the apparatus may be used to maintain proper chain tension while transporting a bicycle without its wheels.

### BACKGROUND OF THE INVENTION

Modern bicycles operate by a chain drive connecting one or more large gears, or chain rings, to a set of smaller gears, or cogs. In this way the operator of the bicycle can change the speed of the bicycle by selecting which combination of chain ring and cog is providing the drive to the drive wheel. Selection of a particular chain ring and cog combination is accomplished by advancing or retarding a mechanism called a derailleur. So called mountain bikes, road bikes and recumbent bikes all use generally the same method to change chain ring and cog combinations.

The derailleur mechanism is a spring-loaded device operated by a cable easily reached by the cyclist. When the cyclist wishes to change the combination of chain ring and cog, the cable is either tightened or loosened. In response, the derailleur either moves to the outside of the bicycle or to the inside. This lateral movement by the derailleur in turn causes the chain to move to the appropriate chain ring or cog. It should be noted that there are many different types of derailleur activation schemes, for example, electrically activated or mechanically activated, but they all advance or retard the chain in the same way. Thus any derailleur activation scheme may be used without departing from the spirit of the present invention.

As with all mechanical devices, the combination of derailleurs, cables, chain rings and cogs presents a problem of maintaining alignment. This is especially true of the new, narrow type competitive ring and cog combinations. The problem is exacerbated by aging of the connecting cables, changes in friction due to deterioration of lubricants, and mechanical wear in the components that make up the shifting system.

To correct for the factors that cause misalignment, the derailleurs are provided with adjustments which set the distance that the derailleur moves when the cyclist operates the shifting mechanism. Historically, there have been two methods used to accomplish the alignment: mount the bicycle on a maintenance stand with the rear wheel in place, or remove the rear wheel and replace it with an axel having a cog or cogs but without the wheel rim and spokes.

Both of the methods for alignment described above suffer from one or more disadvantages. For example, if the rear wheel is mounted it is difficult to reach the derailleur adjusting screws without interfering with the movement of the wheel. Moreover, if the rear wheel is being turned at a high rate of speed, as is the case when adjusting large chain ring-small cog combinations, it is possible to cause injury to the hands of the person doing the alignment. With the second method, while the possibility of injury is not present, the expense of a special fixture is disadvantageous. A further disadvantage is the need for a fixture for each type of chain since the spacing is different for different chains.

As can be seen, the current methods suffer from one or more drawbacks. A further drawback common to these methods is that they require that a cog or cogs be mounted in the drive wheel dropouts. A dropout is a slot used to receive the axel of a wheel. Additional hardware is then needed to clamp the wheel or fixture in place, typically by use of a skewer or nuts. What is needed is a chain tensioning tool that can be used for derailleur alignment that is easily mounted on the bicycle without the need for additional hardware. A further need is to eliminate the possibility of injury to the hands of the person accomplishing the alignment while providing excellent ease of access to the alignment screws of the derailleur.

### BRIEF SUMMARY OF THE INVENTION

Use of the present invention enables the alignment and servicing of the rear derailleur of a bicycle without having the rear wheel or a specialized fixture mounted in the dropouts. For the present invention, the apparatus is placed on the frame of the bicycle and the chain routed over a toothed pulley. A tensioning spring in the apparatus provides the proper chain tension and allows the rear derailleur to be serviced or aligned.

In a first embodiment, the apparatus of the present invention is held in place by two mounting posts and the force from a tensioning spring. In a second embodiment, the mounting posts have opposed ninety degree bends to prevent the apparatus from inadvertently slipping off of the seat stay frame tube. In a third embodiment of the present invention, a second spring is used to provide a holding force for a clamping lever acting on the seat stay frame tube.

One advantage of the present invention is the ability to complete service work on the rear derailleur of a bicycle without the need for the rear wheel to be mounted. This provides the service person significantly more flexibility and ease of use during the alignment of the derailleur. Other advantages and features of the present invention are discussed in conjunction with the figures below.

### BRIEF DESCRIPTION OF THE SEVERAL VIEWS OF THE DRAWINGS

FIG. 1: is a front view of the chain tension apparatus of one embodiment of the present invention.

FIG. 2: is a front view of the apparatus of the present invention showing both the unloaded and loaded position.

FIGS. 3A and 3B: illustrate the mounting detail of a first embodiment of the apparatus of the present invention.

FIGS. 4A and 4B: illustrate the mounting detail of a second embodiment of the apparatus of the present invention.

FIGS. 5A and 5B: illustrate the mounting detail of a third embodiment of the apparatus of the present invention.

FIG. 6: illustrates the operation of one embodiment of the apparatus of the present invention.

### DETAILED DESCRIPTION OF PREFERRED EMBODIMENTS

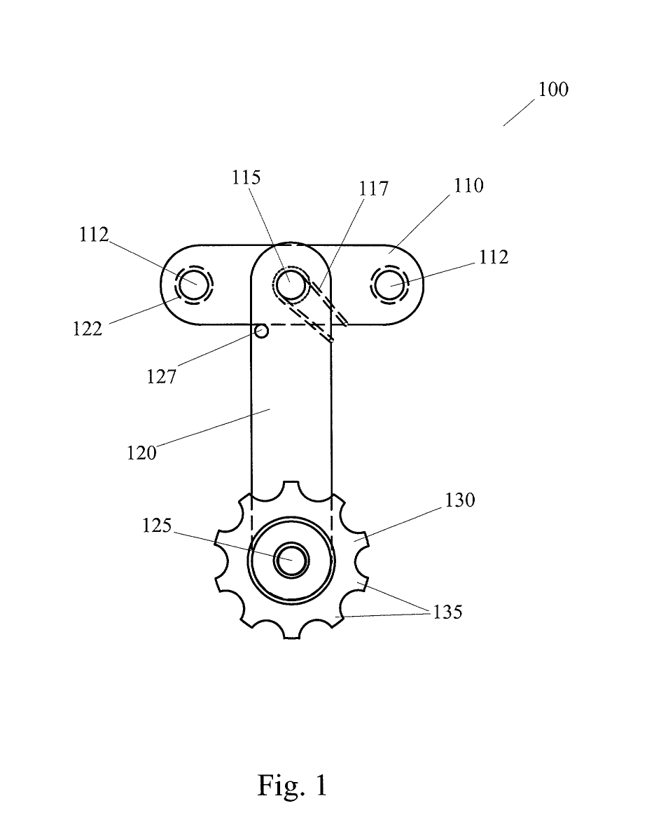

As described briefly above, the present invention allows adjustment of the rear derailleur of a tube frame bicycle without the need for either the rear wheel being mounted or the use of a special fixture or tool. FIG. 1 is a front view 100 of the chain tension apparatus of one embodiment of the present invention. The chain tension tool of the present invention is comprised of a horizontal member 110, a vertical member 120 and a toothed pulley 130.

Horizontal member 110 provides the mounting framework for the chain tension tool of the present invention. In a first embodiment it is comprised of mounting posts 112 and a pivot post 115. In the preferred embodiment of the present invention both the mounting posts 112 and the pivot post 115 are press fit into the horizontal member 110. However, as is known to those of skill in the art, these posts could be fitted by other methods, for example threads, without departing from the spirit of the invention. The mounting posts 112 and the pivot post 115 are fitted on opposite sides of the horizontal member 110. Thus the mounting posts 112 extend away from the viewer in FIG. 1 while the pivot post 115 extends toward the viewer. In the preferred embodiment of the present invention, the mounting posts 112 are covered by a soft material, such as polyvinyl chloride ([PVC] tubing 122 to prevent damage to the surface of the bicycle frame tubing. As will be recognized by those skilled in the art, other materials, for example rubber, may be used without departing from the principles of the invention. As will also be recognized by those of skill in the art, the horizontal member, vertical member, and toothed pulley may be constructed from a wide variety of materials, or a combination of such materials, without departing from the spirit of the invention. By way of example, the horizontal and vertical members could be constructed of aluminum while the toothed pulley could be constructed of plastic.

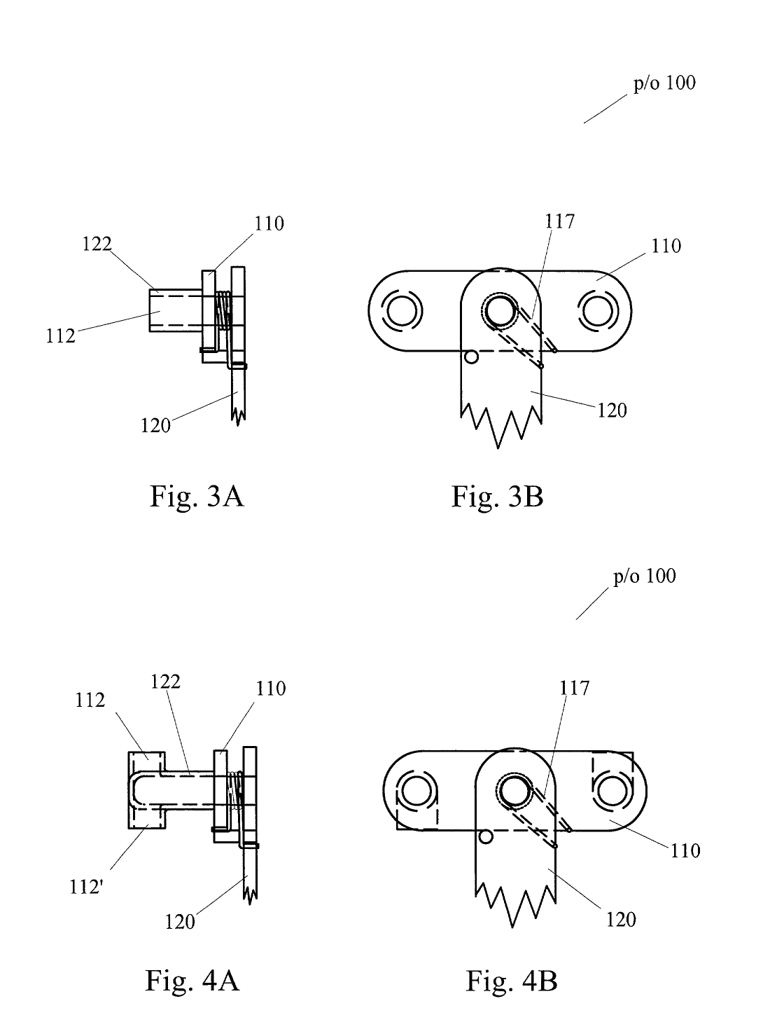

Referring now to FIGS. 3A and 3B, details of the horizontal member 110 for a first embodiment of the present invention are shown. In FIG. 3A the horizontal member 110 is presented in side view. As can be seen, the mounting posts 112, encased in PVC sleeves 122, extend to the left while the pivot post 115 extends to the right. The purpose of the mounting posts 112 is to anchor the chain tension tool to the frame of the bicycle, typically on the seat stay tube. As will be discussed in detail below, rotational pressure is applied to the mounting posts 112 via spring 117 in such a way as to prohibit the tool from rotating or slipping.

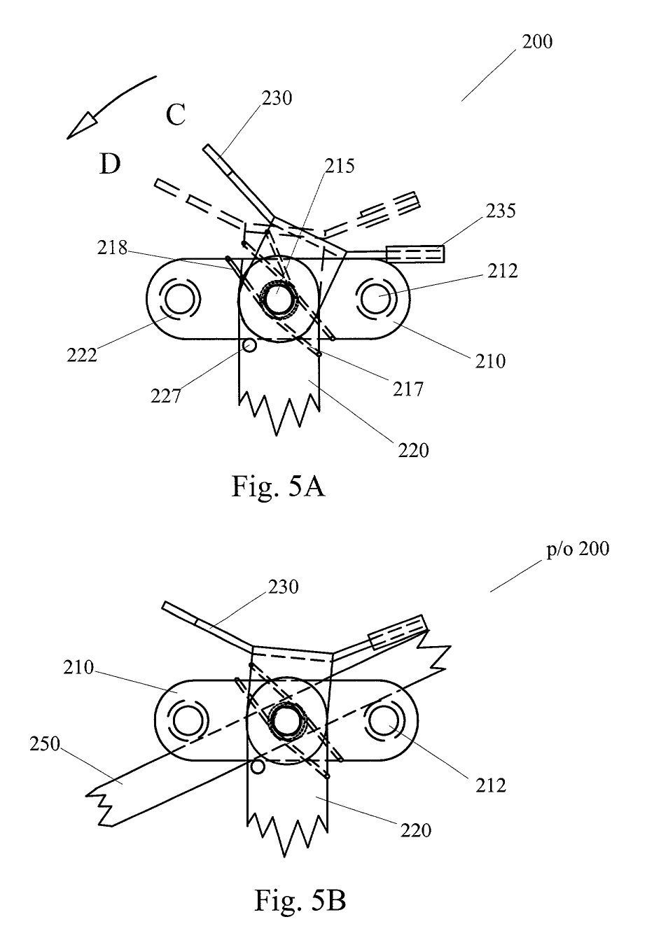

FIG. 4A presents a side view of a second embodiment of the present invention. In this instantiation, the mounting posts 112 and 112′ have had a short ninety degree bend added to the tips. These bends provide further anti-slip characteristics. FIG. 5A shows a third preferred embodiment 200 of the present invention. In this embodiment a spring loaded clamping lever 230 has been added to provide positive clamping of the chain tensioning tool on the frame of the bicycle. The clamping lever 230 pivots around the pivot post 215 which is press fit to the horizontal member 210 in a manner similar to the embodiments discussed above. Rotational pressure is provided by spring 218, also pivoting about pivot post 215. Moving the clamping lever 230 from position C to position D causes spring 218 to compress, providing the necessary rotational force to hold the chain tension tool in position. Mounting posts 212 and PVC sleeves 222 perform the same functions as those for the previous embodiments, thus are not discussed in detail here. The clamping lever 230 has a PVC sleeve 235 similar to and performing the same function as the PVC tubing on the mounting posts 212.

Returning to FIG. 1, vertical member 120 is comprised of rotational stop 127 and pulley pivot post 125. The vertical member has rotational freedom about the axis of the pivot post 115. Rotational stop post 127, which may be mounted by either press fit or threaded means, prevents spring 117 from completely unwinding when no tension is applied by the vertical member 120. Pulley pivot post 125 provides a mount for the toothed pulley 130. Toothed pulley 130 has a self contained roller bearing and is free to rotate in either clockwise or counter clockwise directions, and has teeth 135 that match the pitch of a standard bicycle chain. As will be understood by those skilled in the art, toothed pulley 130 could have teeth 135 with a different pitch without departing from the spirit of the invention. Note that, as will be recognized by all those skilled in the art, toothed pulley 130 may be mounted on pulley pivot post 125 by a number of methods without departing from the spirit of the invention. For example, the toothed pulley could be press fit, retained by a cap screw, or riveted in place.

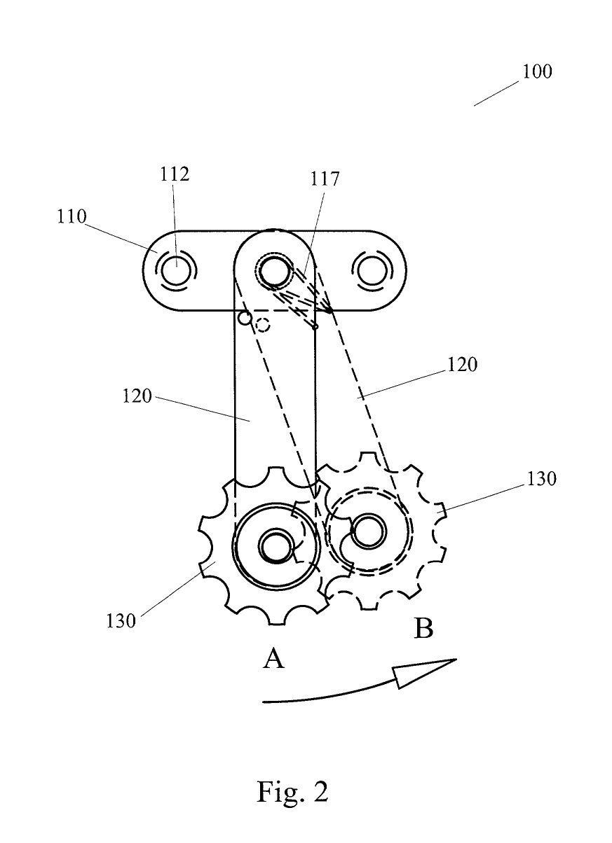

FIG. 2 again shows a front view 100 of the present invention. Further shown is the effect of rotating the vertical member 120 in the counter clockwise direction, as might happen if a chain were routed over the teeth of toothed pulley 130. When vertical member 120 is rotated from position A to position B, spring 117 compresses, creating a clockwise rotational force which could be exerted, for example, against mounting posts 112 via horizontal member 110.

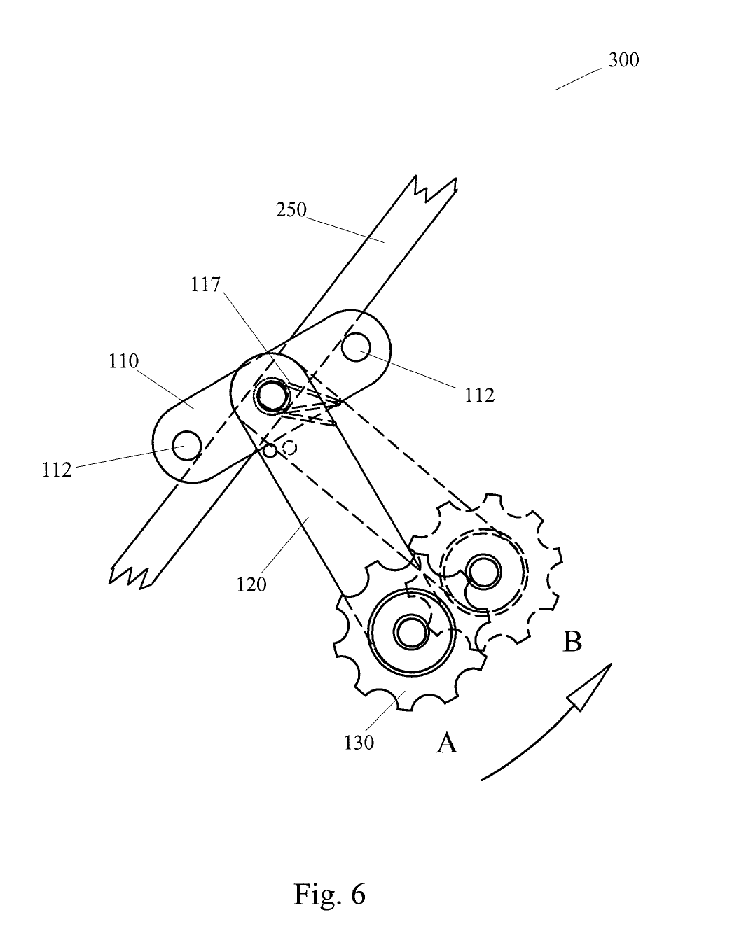

Referring now to FIG. 6, operational drawing 300 is shown. In operation, horizontal member 110 has been positioned over the seat stay tube 250 of a bicycle frame. A standard bicycle chain (not shown for clarity) has been routed over toothed pulley 130 causing vertical member 120 to rotate from position A to position B compressing spring 117. Normally, horizontal member 110 would rotate counter clockwise in reaction to the compression of spring 117. However, using mounting posts 112 as stops, pressure is applied to the seat stay tube 250 causing the chain tensioning tool to remain stationary. Advantageously, appropriate tension is applied to the chain simultaneously, causing the rear derailleur (not shown) to deploy to the normal or near normal operating position. In this position the derailleur may be adjusted without the need for mounting of the rear wheel or a specialized fixture.

Returning briefly to FIG. 5, in FIG. 5B operation of the clamping lever 230 is shown. As with previous embodiments, horizontal member 210 in combination with mounting posts 212 is used to locate the chain tensioning tool on the seat stay tube 250. However, as can be seen, the clamping lever 230 provides additional independent pressure on seat stay tube 250, allowing the chain (not shown for clarity) to be removed without disturbing the position of the chain tensioning tool.

One advantage of the present invention is the elimination of the safety hazard accompanying high speed wheel motion. Since the rear wheel is not required, the chain and associated drive train components may be turned at high speeds without concern for the close proximity of the rotating mass of the wheel to the hands of the person accomplishing the alignment.

A second advantage of the present invention is the open access to the adjusting screws of the derailleur. Without the wheel spokes of a mounted rear wheel or the cogs of a mounted specialized fixture, the screws are readily accessed and adjusted.

A third advantage of the present invention is that no additional hardware is required. The chain tension tool is self mounting and self adjusting, eliminating any complex setup required by specialized fixtures.

A fourth advantage of the present invention is that one size fits all. Bicycle chains come in a fixed pitch regardless of thickness. Since the pitch of the pulley teeth are set for a standard bicycle chain, all gauges of chains may be serviced using the chain tensioning tool disclosed.

A fifth advantage of the present invention is that it is economically superior to existing solutions. Both the rear wheel and the specialized fixture approach require expensive hubs, bearings and a skewer to secure the alignment device in the frame dropouts. The present invention simply mounts to the seat stay of the bicycle frame, held in place by its own means.

A sixth advantage of the present invention is that it can be used to transport the bicycle while maintaining proper tension on the rear derailleur. Many modem carrying cases have been developed which allow a high degree of protection during transit. However, the frame and wheels must be separated, leaving the chain free to tangle and the derailleur exposed to damage. Use of the chain tensioning tool positions the derailleur and chain such that they are less vulnerable.

What is claimed is:

1. A chain tensioning apparatus for aligning the rear derailleur of a tube frame bicycle, comprising:
a horizontal member with a front surface and a rear surface;
said horizontal member further comprising a first mounting post and a second mounting post extending outward from opposite ends of said rear surface of said horizontal member and a pivot post extending outward from the center of said front surface of said horizontal member;
a vertical member with a front surface and a rear surface;
said vertical member further comprising a mounting means at one end of said front surface of said vertical member such that said mounting means passes through said vertical member to said rear surface of said vertical member allowing said vertical member to be mounted on said pivot post on said horizontal member;
a rotational stop post extending outward from said rear surface of said vertical member and on the same end as said mounting means, and;
a pulley pivot post extending outward from the other end of said front surface of said vertical member;
a compression spring mounted about said pivot post on said horizontal member with one end of said compression spring anchored to said horizontal member and the other end of said compression spring anchored to said vertical member such that said compression spring works to cause said vertical member to rotate in a counter clockwise direction about said pivot post on said horizontal member, and;
a toothed pulley mounted on said pulley pivot post on said vertical member, said toothed pulley being free to rotate in a clockwise or counter clockwise direction such that when said toothed pulley is engaged with a bicycle chain and said mounting posts on said horizontal member placed so as to contact a bicycle frame member, the force applied by said bicycle chain upon said pulley causes said compression spring to generate a force sufficient to hold said tensioning apparatus in place.

2. The horizontal member of claim 1 where the mounting posts are straight.

3. The mounting posts of claim 2 where said mounting posts are covered with a soft material.

4. The horizontal member of claim 1 where the mounting posts have a right angle bend such that said right angle bend on one end of said horizontal member is oriented upward and said right angle bend on the opposite end of said horizontal member is oriented downward.

5. The mounting posts of claim 4 where said mounting posts are covered with a soft material.

6. The chain tensioning apparatus of claim 1 further comprising:
a clamping lever having mounting means at the center such that said clamping lever mounts about the pivot post on the horizontal member of the chain tensioning apparatus, said clamping lever further having two lever arms extending horizontally on either side of said pivot post mounting means, one arm used to contact a bicycle frame member and the other arm used to apply counter clockwise force to said clamping lever;
a second compression spring mounted about said pivot post on said horizontal member with one end of said compression spring anchored to said horizontal member and the other end of said compression spring anchored to said clamping lever, said spring causing said clamping lever to rotate in a clockwise direction about said pivot post on said horizontal member such that when the mounting posts on said horizontal member are placed so as to contact said bicycle frame member, the force applied by said clamping lever upon said bicycle frame member causes said compression spring to generate a force sufficient to hold said tensioning apparatus in place.

7. The clamping lever of claim 6 with the addition of a soft material on the end of said lever arm coming in contact with the bicycle frame member.
